(19) United States
(12) Patent Application Publication
(10) Pub. No.: US 2006/0159262 A1
(43) Pub. Date: Jul. 20, 2006

(54) Device for marking and restoring multimedia signals

(76) Inventors: Christine Guillemot, Chantepie (FR); Stephane Pateux, Gregoire (FR); Gaetan LE Guelvouit, Rennes (FR)

Correspondence Address: FOLEY AND LARDNER LLP;SUITE 500, 3000 K STREET NW, WASHINGTON, DC, 20007, US

(21) Appl. No.: 10/532,805

(22) PCT Filed: Oct. 28, 2003
(86) PCT No.: PCT/FR03/03208

§ 371 Date: Dec. 9, 2005

(30) Foreign Application Priority Data
Oct. 30, 2002 (FR) 0213605

(51) Int. Cl. H04N 7/167

(52) U.S. Cl. 380/210; 380/255

(57) ABSTRACT

The invention concerns a device for processing a signal comprising a signal transforming module (5) capable of producing a transformed signal (xi) from an original signal and a mixing module (10) for marking the transformed signal with a marking message (M). The mixing module (10) comprises: a formatting module (14) capable of calculating a response of the transformed signal (rx) to the demodulation of a first set of carriers (Gj) defined by keys protecting the message and of calculating a marking information ({bj}) based on said response and code words (U) associated with the marking message, a modulator (18) capable of modulating marking data supplied by the formatting module (14) with a given coefficient (Gij) of the carriers of the first set of carriers, and of modulating in amplitude the resulting coefficient by a corresponding quantity related to the energy weighting term of the marking message and to the set of carrier, thereby supplying a marking coefficient, an adder (20) capable of adding the marking coefficient to the corresponding coefficient of the original transformed signal.

The present invention relates to a device for marking and restoring multimedia signals. Marking of a multimedia signal, a process also known as watermarking, involves invisibly embedding a message in the multimedia signal before it is transmitted so as to be able to restore it in a legible manner on reception. To ensure the secrecy of the embedded message, a set of private or public keys is often used to deny unauthorised persons the possibility of finding or removing the hidden message.

There are numerous application domains for a method of marking multimedia signals.

Firstly, in a protection context, it can be useful to insert a hidden message into the content of a multimedia signal making it possible to subsequently identify the content, to identify the owner of the content, or to determine the rules governing the use of this content, such as distribution rights or copyright, for example.

However, the content of the multimedia message can be degraded in various ways. For example, it can be degraded following the use of a representation format that introduces degradation, such as lossy coding (for example JPEG for fixed images, MPEG for video, or MP3 for audio), or by various acquisition methods such as analogue recording, printing, or scanning in the case of an image.

The content of a multimedia signal can also be degraded by reformatting, for example by selecting a portion of an audio file or cropping an image.

The content of a multimedia signal can also be subject to intentional attacks with the aim of defeating the message extraction process. This can be done by adding noise to the signal, by using a filtering technique or by using desynchronising techniques (for example, geometric transformation in the case of images, or change of frequency in the case of sound files). In this kind of application, it is important to ensure that the embedded message can be extracted correctly regardless of whether or not the content has been intentionally modified.

Another application domain relates to the provision, by means of a watermarking process, of a channel for the transmission of information in an imperceptible manner and linked to the actual content of the multimedia signals. In particular, this can be useful in the case of transcoding or subsequent dissemination of the content, where the existence and/or the long-term viability of such a transmission channel is not guaranteed. This side channel can then be used, depending on its capacity, to transmit any useful information. By way of example, this can include the insertion of meta-data describing the watermarked content (such as a content identifier or a description of content elements) which can subsequently be used to provide a value added service, or ancillary information (such as a teletext service or subtitles). Here again, it is important to be able to extract this information after the content has been manipulated in various ways, principally transcoding, and therefore to have a robust watermarking system.

Known marking devices rely on a COFDM type modulation technique, commonly used in digital communications, wherein bits bj define the message and are modulated by several carriers defined by public and private keys. The signal thus modulated is added to the original signal. On extraction, demodulation is used to restore the inserted bits bj. However this marking technique suffers from a number of imperfections in that the host signal can interfere with the carriers used, the inserted signal may be visible, or the resynchronisation may be imperfect.

The aim of the invention is to remedy this situation.

To this end, the invention proposes a signal processing device including a signal transformation module capable of producing a transformed signal from an original signal and a mixing module intended to mark the transformed signal with a marking message. According to a characteristic of the invention, the mixing module includes:

a formatting module capable of calculating a response of the transformed signal to the demodulation of a first set of carriers defined by keys protecting the message, and of calculating a marking information based on this response and code words associated with the marking message,

a modulator capable of modulating the marking data supplied by the formatting module with a given coefficient of the carriers of the first set of carriers, and of modulating in amplitude the resulting coefficient by a corresponding quantity related to the energy weighting term of the marking message and to the set of carriers, thereby supplying a marking coefficient,

an adder capable of adding the marking coefficient to the corresponding coefficient of the transformed original signal.

The amplitude modulation performed by the modulator thus enables the added signal to be rendered hardly visible. Moreover, the device proposed by the invention implements a channel coding technique with side information. In this technique, the components of the marking data are floating values defined in a manner such that their insertion compensates the response of the host signal.

According to another characteristic of the invention, the formatting module includes a demodulator intended to perform the demodulation, this demodulator being capable of multiplying each coefficient of the transformed signal by the corresponding coefficient of a given carrier in the first set of carriers, by the perceptual weight of distortion and by the attenuation factor associated with the transformed signal coefficient, and adding the coefficients thus determined, thereby supplying a component of the response of the transformed signal.

The formatting module is also capable of calculating the marking information from a predetermined parameter, a first vector associated with a particular code word of the marking message, and a second vector forming in conjunction with said first vector a normalised orthogonal base defining a hyperplane.

In particular, the particular code word is obtained by minimising a quadratic error criterion between the code words associated with the marking message and the normalised value of the response of the transformed signal to the demodulation.

Each component of the second vector is proportional to the difference between the corresponding component of the demodulation response and the projection of the vector representing the demodulation response on a unit vector colinear with the first vector.

The predetermined parameter corresponds to the angle between the vector representing the marking information and the first vector, this parameter being determined by maximising the relationship:
K.(uo+cos θ)²−(vo+sin θ)²
in which:

uo denotes the scalar product between the vector representing the demodulation response and the first vector, divided by the number m of components of the demodulation response,

vo denotes the scalar product between the vector representing the demodulation response and the second vector, divided by the number m,

K=1/(2^{2(C+R)m}−1), C and R respectively denoting the number of useful bits and adaptation bits to the original signal, and m denotes the number of components of the demodulation response.

According to another characteristic of the invention, the mixer includes a scaling module capable of modulating in amplitude each signal coefficient supplied by the adder circuit by a quantity related to the energy weighting term of the marking message and the variance of the corresponding coefficient of the transformed signal.

This quantity is defined by σₓᵢ²/(σₓᵢ²+σ_{wi}²), where σₓᵢ² is the term defining the energy of the marking message and σₓᵢ² is the variance of the corresponding coefficient of the transformed signal.

This amplitude modulation corresponds to a Wiener filter and serves to limit the noise thus added to the host signal.

According to another characteristic of the invention, the device includes an inverse transformation module at the mixer output, capable of performing an inverse transformation on the marked signal relative to that performed by the transformation module, and a signal transformation module capable of transforming the resynchronised marked signal, thereby supplying a transformed marked signal.

The device can also include an extraction device at the output of the inverse transformation module to extract the message from the marked signal, this extraction device incorporating a resynchronisation module capable of resynchronising the marked signal.

In particular, the extraction device is capable of calculating a response of the resynchronised marked signal to the demodulation of a second set of carriers defined by message protection keys, which provides an estimation of the embedded marking information.

In an alternative embodiment, the first set of carriers and the second set of carriers are identical.

Furthermore, the extraction device can include a demodulator intended to perform the demodulation, this demodulator being capable of multiplying each coefficient of the resynchronised marked signal by the corresponding coefficient of a given carrier in the second set of carriers and by the perceptual weight of distortion associated with said coefficient of the resynchronised marked signal, and of adding the coefficients thus determined, which supplies one component of the marking information estimate.

In addition, the extraction device can include a carrier generating module capable of generating the second set of carriers from the message protection keys.

The extraction device can also include a decoder capable of determining the code word closest to the marking information estimate by maximising a quadratic error criterion between a set of code words and the marking information estimate, which supplies the marking message.

According to another characteristic of the invention, the processing device can also include an insertion parameters definition module coupled to the mixing module capable of determining the energy weighting term of the marking message and the attenuation factor from the intrinsic signal properties, the application domain constraints, and the properties of the transformation used.

In particular, the insertion parameters definition module is capable of calculating two global insertion parameters in relation to the insertion distortion D_{xy} between the original signal and the marked signal in the transform space, the maximum allowable attack distortion D_{xy′} between the original signal and the resynchronised marked signal, in the transform space, and the signal to noise ratio between the energy of the marking message and the attack noise Eb/No.

The two global insertion parameters are calculated by searching for the parameters λ and χ which maximise the relationship:
Eb/N₀+λD_{xy′}−χD_{xy′}

The insertion parameters definition module is capable of calculating the energy weighting term of the marking message and the attenuation factor based on the two global insertion parameters thus determined.

Other characteristics and advantages of the invention will become apparent by reading the following description and by reference to the figures in the attached diagrams in which:

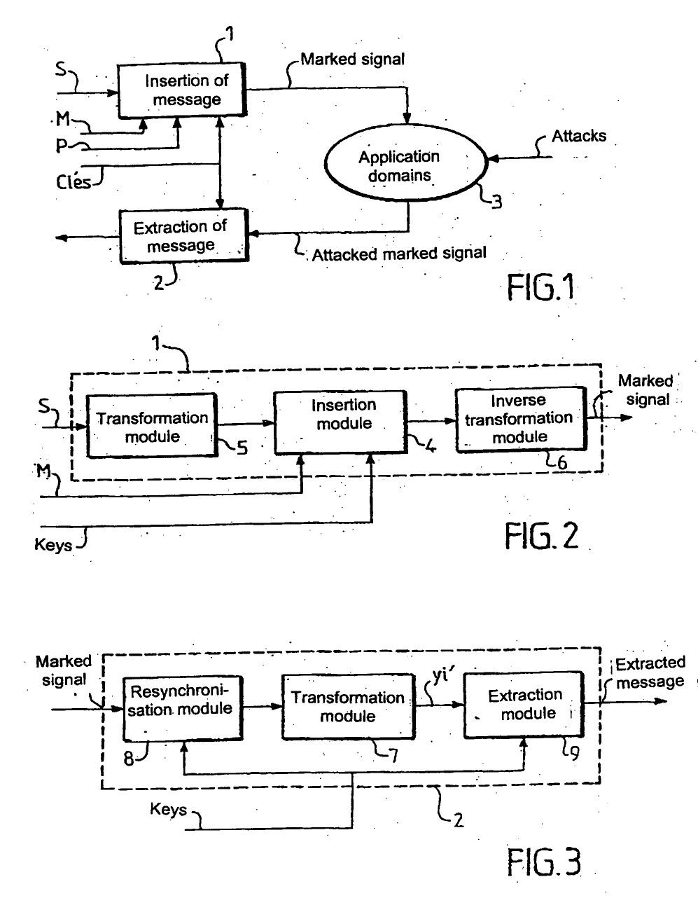

FIG. 1 illustrates the configuration of a system for the transmission of marked multimedia signals for implementation of the invention,

FIG. 2 is a general arrangement of the insertion device in FIG. 1,

FIG. 3 is a general arrangement of the extraction device in FIG. 1,

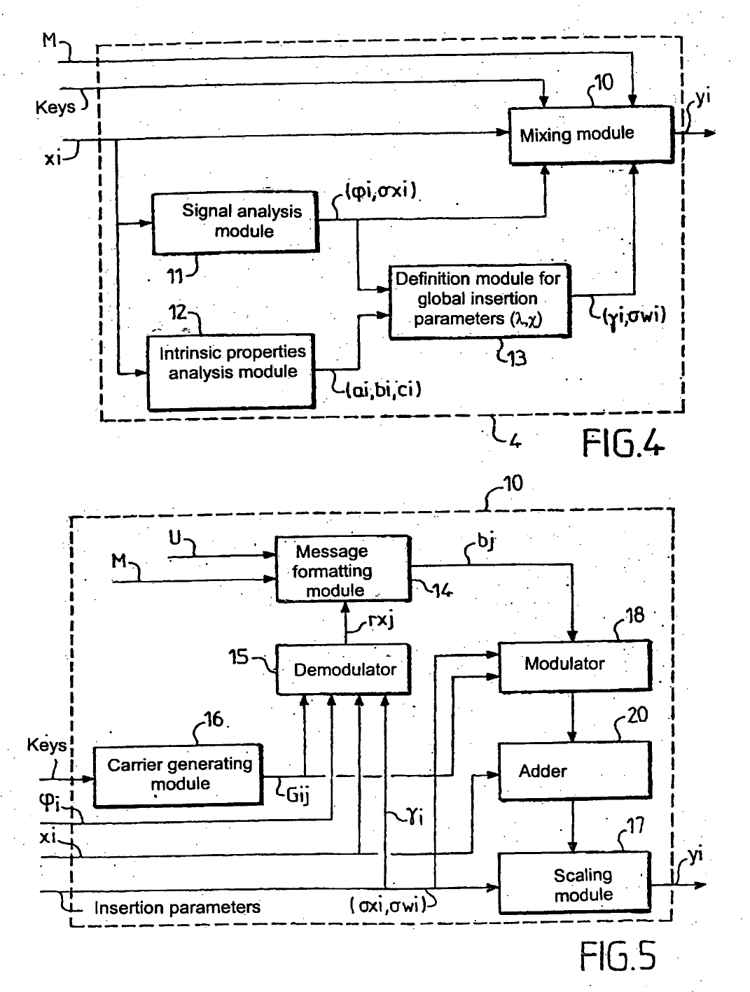

FIG. 4 is a block diagram of the insertion module in FIG. 2,

FIG. 5 is a block diagram of the mixing module in FIG. 4,

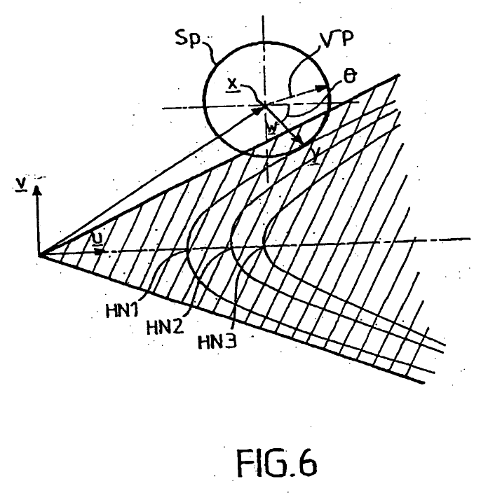

FIG. 6 is a graphical representation enabling the robustness of a signal to be assessed, following the addition of noise of given energy,

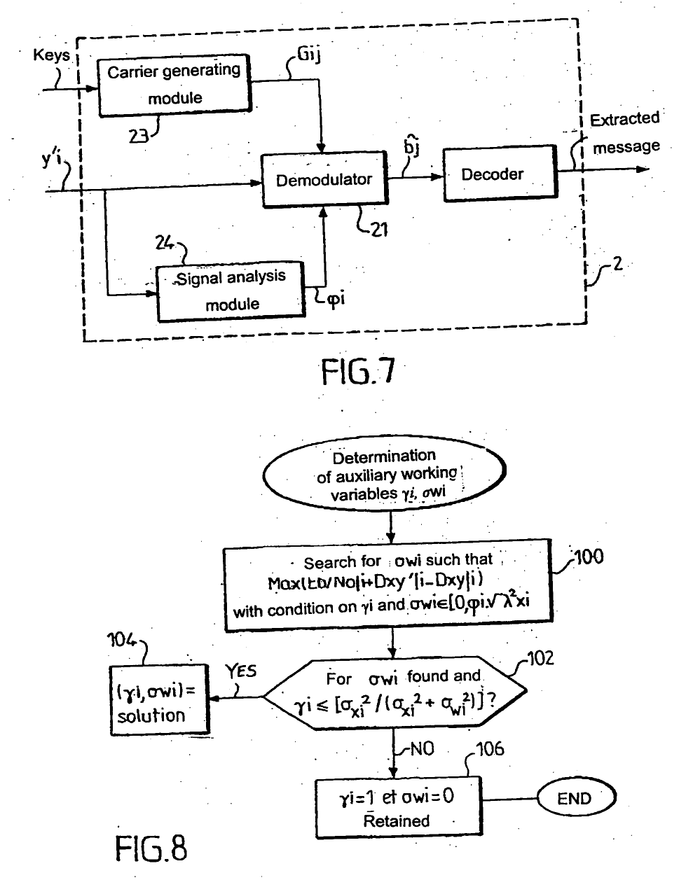

FIG. 7 is a block diagram of an embodiment of the extraction module in FIG. 3, and

FIG. 8 depicts the mechanism used in one embodiment.

Appendix I lists the various notations used in the description.

Appendix II lists the mathematical formulae used in the description.

The figures and the attachments to the description essentially include elements that are certain in character. They can therefore serve not only to aid understanding of the description, but will also contribute to the definition of the invention, as applicable.

The device for marking and restoring multimedia signals for implementation of the invention, depicted diagrammatically in FIG. 1, comprises a marker message insertion device 1 and a marker message extraction device 2.

The message insertion device 1 generates a marking for a multimedia signal S to be transmitted through an application domain 3, based on the content of a marker message M. The marking technique used is an additive technique implementing a spread spectrum modulation process. It is similar to the COFDM modulation technique commonly used in digital communications. The components bj which define the marker message M are modulated by carriers defined by public and private keys, and applied to the input of the insertion device. The signal thus modulated is added to the original signal S. On extraction, a demodulation process is applied to restore the embedded components bj of the marker message.

According to an advantageous characteristic of the invention, to impart sufficient robustness and to ensure that the embedded signal is not visible, the added signal is modulated in amplitude as a function of the energy of the mark added to each signal coefficient in the transform domain. Following this addition, a further amplitude modulation is applied to each marked coefficient. This second modulation corresponds to a Wiener filter intended to limit the noise thus added to the host signal.

Conventionally, the components bj correspond to the bits defining the message to be embedded after the possible application of correction codes. In the scheme presented here, a channel coding technique with side information is used. The components bj of this marking model are floating value data in this case.

The marking process described below takes such a marking model into account and optimises it so as to resist attacks of the noise addition, filtering and partial desynchronisation type, modelling quite well the various processes to which a signal may be subjected.

The insertion device depicted in FIG. 2 includes an insertion module 4 coupled upstream to a transformation module 5 and downstream to an inverse transformation module 6. In this configuration, the original signal S, defined in a first space, is applied to the transformation module 5 to be transformed into a number n of coefficients xi, defined in a second space. Any transformation process can be used, not excluding identity transformation which involves working directly on the original signal. Different transformations can be used, such as Fourier transformation, discrete cosine transformation, or wavelet transformation for example.

After transformation of the original signal S, the message M to be embedded is applied in the insertion module 4 to the different coefficients xi of the transformed signal to form marked coefficients yi. The marked coefficients yi are then applied to the inverse transformation module 6 to undergo inverse transformation relative to that applied before marking, thereby restoring a marked signal close to the original signal. This marked signal is then transmitted to an extraction device, as depicted in FIG. 3.

In FIG. 3, the extraction device 2, which is shown enclosed within a dotted line, includes a transformation module 7 coupled upstream to a resynchronisation module 8 and downstream to an extraction module 9. The marked signal received is first resynchronised by the resynchronisation module 8, then transformed by the transformation module 7 into a series of coefficients yi′ using a transformation identical to that applied in the insertion phase. The coefficients yi′ are then applied to the extraction device 9 to extract the marking signal M. Any resynchronisation process can be used (exhaustive search related to the insertion of a pilot signal or to an intrinsic property of the mark), or it may be implicit by virtue of insertion into a domain invariant to desynchronisations (for example, amplitudes in a Fourier domain or Fourier-Mellin transformation).

In the following description, the notations listed in Appendix I are used.

An embodiment of the insertion module 4 is depicted in FIG. 4, enclosed within a dotted line. This module includes a mixing module 10, a signal analysis module 11, an intrinsic properties analysis module 12, and a global insertion parameters definition module 13.

The insertion of a message M into a signal with coefficients xi begins in module 11 by an analysis which serves to define the signal-related properties, i.e. the perceptual weighting in the distortion metric φi, defined for each coefficient xi of the transformed original signal as a function of the variance value σₓᵢ² of the corresponding coefficient. The perceptual weighting φi of each coefficient xi of the signal is a function of the type of signal processed, the transformation used and the values of the observed signal.

Any method can be used to estimate the variances σₓᵢ² of the signal (Appendix I-1). It is possible, for example, to use a weighted quadratic mean in a vicinity (or sliding quadratic mean), according to relationship (2) in Appendix II to the description. In this relationship, vi denotes a vicinity of the coefficient in question.

The naive value φi=1 corresponds to the conventional mean quadratic error. An example of a model more adapted to images taking account of the masking phenomenon can be defined by relationship (3) presented in Appendix II to the description. In this relationship, σ_{bi}² corresponds to a visibility threshold for the i-th coefficient, and Vi corresponds to a local masking force factor defined by a sliding mean on the vicinity vi of the coefficient considered, according to relationship (4) in Appendix II. ρ is a parameter in the order of 0.5 to 1 (typically the values 0.5, 0.6 and 0.7 are most commonly used).

Based on the application constraints and the properties of the transformation used, application parameters ai, bi and ci are determined by the intrinsic properties analysis module 12, for each coefficient xi. The parameter ai represents the degree of interference with the original signal, the parameter bi the degree of auto-interference of the embedded signal, and the parameter ci is the site attenuation parameter.

Application parameters ai, bi and ci are used to take account of a desynchronisation phenomenon at each site, i.e. on each carrier frequency of the transform space. For example, for a desynchronisation Δᵢ at the i-th site, representing the location precision of the coefficient, the values defined by relationship (5) in Appendix II to the description will typically be used.

Based on the parameters φi, σₓᵢ², ai, bi and ci supplied by modules 11 and 12, module 13 estimates the global insertion parameters λ and χ. Based on these global insertion parameters, module 13 then determines the insertion parameters γi and σ_{wi} defining the intrinsic properties of the marking signal. The first insertion parameter γi represents the attenuation factor of the site considered, and the second insertion parameter σ_{wi} represents the marking energy weighting term.

Once the various parameters have been established, insertion of the message M into the transformed signal {xi} is performed by the mixing module 10 based on the application parameters ai, bi and ci, calculated by module 12, the perceptual weighting {φi} and the variance {σₓᵢ²} calculated by the signal analysis module 11, and the insertion parameters σ_{wi} and γi estimated by module 13.

The mixing module includes a demodulator 15 which estimates the response rx of the transformed original signal to a demodulation of a first set of carriers {Gⱼ}. This demodulation takes into account the perceptual weighting values φi and the attenuation factor values γi.

The mixing module 10 also includes a carrier generator 16 which generates the first set of m carriers {Gⱼ} based on public or private keys. Each component rxj of the response of the transformed original signal is determined from the relationship Σ_{iε[1,n]}φi(γi.xi).Gᵢⱼ, where Gᵢⱼ denotes the i-th coefficient of the j-th carrier supplied by the carrier generator 16.

The mixing module 10, illustrated in FIG. 5, also includes a message formatting module 14 capable of providing m components bj defining the message to be embedded, based on the responses rxj supplied by the demodulator 15 and a set of code words U applied to the formatting device 14 at the same time as the marking message M.

The values of the n coefficients {yi} of the signal after marking are then calculated from these components bj, via a modulator 18, an adder 20 and a scaling module 17, in accordance with relationship (6) in Appendix II to the description.

More precisely, for each of the bits of the public or private keys, the carrier generating device 16 supplies the carriers Gᵢⱼ to the modulator 18 to modulate the components bj. The modulator 18 performs a modulation of the components bj of the marking information by the carriers Gᵢⱼ to provide n coefficients relating to the marking information. The i-th coefficient relating to the marking information is given by the relationship Σ_{jε[1,m]}bjGᵢⱼ.

The modulator 18 can also perform an amplitude modulation of these coefficients relating to the marking information, by the term k₂ᵢ=σ_{wi}/Σ_{jε[1,m]}Gᵢⱼ², relating to the energy weighting term of the marking message σ_{wi} and to the carriers Gᵢⱼ.

The modulator 18 then provides to the adder circuit 20 a number n of coefficients relating to the marking information of the form:
x′i=σ_{wi}/Σ_{jε[1,m]}Gᵢⱼ²*Σ_{jε[1,m]}bjGᵢⱼ.

The adder circuit 20 adds these coefficients x′i to the coefficients xi of the transformed original signal. This result is then scaled by the scaling module 17 based on the term k₁ᵢ=σₓᵢ²/(σₓᵢ²+σ_{wi}²), expressed in relation to the values of the variance σₓᵢ² of the signal in the transform space for the various coefficients xi and of the energy weighting term σ_{wi} of the added mark. This term corresponds to a Wiener filter.

The scaling module 17 therefore provides the signal marked with coefficients yi in the transform space, as indicated by relationship (6) in Appendix II.

The formatting module 14 of the mixer 10 will now be described in more detail. The formatting module 14 receives a message M to be embedded, which is defined on the basis of a set of code words U. This set is of size 2^{C+R} and is divided into 2^{C} subsets U_{M}. Each of these subsets includes 2^{R} code words and are associated with each of the 2^{C} possible messages. The various code words are defined in an m-ary space and are such that: 1/m. Σⱼ (U²ₖⱼ)=1 for jε[1,m].

Any method of generating these code words and grouping these code words into subsets U_{M} can be used. These notably include code words generated by a system of correction codes (for example, the first C bits are useful bits which identify the message, while the last R bits are host signal adaptation bits which identify the code word used for the message M).

The formatting module 14 also receives the response rx of the transformed original signal, supplied by the demodulator 15. To determine the components rxj of this response, the demodulator 15 first provides an estimate of these according to the relationship E_{jε[1,n]}φi (γi.xi).Gᵢⱼ, as indicated above. Then it renormalises this estimate into rxj in an appropriate manner such that the insertion of rxj, using the technique proposed previously by the relationship (6), compensates the response of the host signal at the point of attack in question defined by the attack parameters, whether this attack takes the form of added noise and filtering or partial desynchronisation.

The formatting module 14 then looks for a code word Uₖ, among the code words associated with the message M to be inserted, by minimising the square deviation criterion defined by relationship (7) in Appendix II to the description, based on the response rx to the transformed original signal. This code word represents a vector Uₖ having m components Uₖⱼ.

Based on this code word Uₖ and the response rx supplied by the demodulator 15, the formatting module 14 defines a vector V′ of dimension m having components defined by relationship (8) in Appendix II, where the notation <A|B>=ΣAjBj represents the scalar product between two vectors A and B.

Based on this vector V′, the formatting module 14 defines a vector V of components Vj according to relationship (9) in Appendix II, such that the vector V is proportional to the vector V′ and <V|V>=0 or <V|V>=m applies depending on whether or not V′ is null. In particular, this vector V has the property of being orthogonal to the vector Uₖ.

The formatting module 14 then looks for the value of a parameter θ maximising the relationship (10) formulated in Appendix II, based on parameters u0, v0 and K determined in relation to the response to the transformed original signal rx, the vector Uₖ and the vector V. These parameters u0, v0 and K are defined by the relationships (11) also included in Appendix II.

Finally the formatting module 14 calculates the values of the components bj from the parameter θ thus determined, and of the components Uₖⱼ and Vⱼ of the vectors Uₖ and V, according to relationship (12) in Appendix II.

The purpose of calculating values of the components bj is to define the signal to be added such that the response of the demodulator used in the extraction phase is consistent with that of the code word Uₖ and as robust as possible. The robustness is defined by equation (10). This robustness corresponds to an energy level of the noise that can be added without leaving the cone associated with the code word Uₖ in FIG. 6.

Referring to FIG. 6, the vectors Uₖ, represented by the vector u, and the vector V, represented by the vector v, form a normalised orthogonal base defining the hyperplane containing the response vector rx and the code vector Uₖ. In this hyperplane, the displacement (cos θ, sin θ) defines the signal that can be added. To maximise equation (10), it is then necessary to look for the vector of components bj maximising the robustness. Applied to each component of the modulation (i.e. values bj), this is then expressed by equation (12).

FIG. 6 presents a geometric interpretation of this definition. The cone represented by the cross-hatched area represents the set of values leading to correct decoding of the code word. Sp represents the sent of points satisfying a power constraint P of the signal capable of being added (here P=1). The vector w corresponds to a vector of components bj and x corresponds to the vector rx. The hyperbolae Hn correspond to the responses of constant robustness (i.e. following the addition of a noise of given energy).

A similar principle of signal definition has been proposed by Cox et al in an article entitled “Watermarking as communications with side information”, Proc. IEEE, 87(7):1127-1141, 1999, in the context of watermarking applied directly to the original signal, and in a detection context. Detection differs from extraction in that the presence of a known message U is sought. Also, the interpretation of the parameter K in equation (10) differs. In the paper by Cox et al, the parameter K is linked to a presence hypothesis test, whereas in extraction it ensures that the correct message is decoded (opening of the cone in FIG. 6 then depends on the dictionary used—see equation (11)).

This technique aimed at limiting host signal interference corresponds to the technique of channel coding with side information. The general principle of this channel coding technique was initially proposed by Costa in an article entitled “Writing on dirty paper”, IEEE Trans. Info. Thy, 29(3):439-441, May 1983. In the context of the invention, this technique is applied on the information obtained from demodulation of the carriers Gij.

The global insertion parameters definition module 13 defining the intrinsic properties of the marking device is described in greater detail below. The definition module 13 first looks for the global parameters pair (λ,χ) to define the insertion parameters.

The optimal pair (λ,χ) sought can be defined by specifying two of the following three properties:

insertion distortion D_{xy} between the original signal x and the marked signal y, in the transform space, calculated according to a relationship similar to that given by relationship (1) in Appendix II;

maximum allowable attack distortion D_{xy′} between the original signal x and the resynchronised marked signal y′, in the transform space;

the performance measure Eb/N₀ of the marking system.

For example, for given distortions D_{xy} and D_{xy′}, the system looks for the pair (λ,χ) yielding the highest value of the ratio Eb/N₀, or for given Eb/N₀ and D_{xy′}, the system looks for the pair (λ,χ) yielding the highest value of D_{xy′}, or for given Eb/N₀ and D_{xy′}, the system looks for the pair (λ,χ) yielding the smallest value of D_{xy}.

The values of D_{xy}, D_{xy′} and Eb/N₀ are expressed in relation to (λ,χ) according to relationships (13) and (14) formulated in Appendix II to the description.

Having determined the global insertion parameters (λ,χ), module 13 then determines the insertion parameters γi and σ_{wi}; γi and σ_{wi} are auxiliary working variables, functions of λ and χ, which define the insertion properties for a site i corresponding to the position of a coefficient xi in the spectrum of the transformed signal. For a site i, given the global parameters (λ,χ) and the local parameters ai, bi, ci and σₓᵢ, the pair (yi, σ_{wi}) is determined by executing the steps of the flow diagram illustrated in FIG. 8.

At step 100, σ_{wi} is sought, in the interval [0, φi√λσₓᵢ²/ci] which maximises function (16) of Appendix II, with γi given by relationship (17) in Appendix II.

At step 102, for the point found, the device tests whether γi≧0 and γi≦[σₓᵢ²/(σₓᵢ²+σ_{wi}²)]:

If γi≧0 and γi≦[σₓᵢ²/(σₓᵢ²+σ_{wi}²)], the pair (γi, σ_{wi}) is retained at step 104;

If not, at step 106, the pair (γi=1, σ_{wi}=0) is used. That is no marking is performed at this site.

In particular, in the case where ai=bi:

if λ>χ or if σₓᵢ<[ci/(φi√ai√(χ−λ)], the pair (γi, σ_{wi}) given by relationships (18) in Appendix II is used;

if not, the pair (γi=1, σ_{wi}=0) is retained.

It will be noted that when ai=bi=1, σ_{wi}=φi.σₓᵢ².√λ/ci.

The theoretical basis underpinning the developments described above is as follows. The different expressions used to define the insertion parameters correspond to expressions associated with a statistical model of the various signals and with a fairly generalised attack model. The coefficients xi are assumed to obey a Gaussian probability law with a mean of 0 and variance σₓᵢ², and are assumed to be independent. The attacks considered are of the “scaling” type (factors γi) and the addition of Gaussian noise of variance σ_{δi}². In this case: yi′=(γi/γ_{wi})yi+δi with γ_{wi}=σₓᵢ²/(σ_{wi}²+σₓᵢ²).

The scale factor also makes it possible to take proper account of the filtering techniques that can be applied. The novelty of the approach proposed here is to consider signals that are not identically distributed, the use of a perceptual metric, the inclusion of partial desynchronisation, and the use of an insertion/extraction technique based on the use of a spread spectrum COFDM (Coded Orthogonal Frequency Division Multiplex) modulation applied to all of the coefficients.

To define the parameters σ_{wi}² defining the insertion energy, it is also possible to consider a game between an attacker and a defender according to game theory. The attacker knowing the system used tries, in accordance with the known Kerckhoffs principle, to minimise the performance measure of the system Eb/N₀ under a maximum attack distortion constraint D_{xy}_{_{—}}Max.

On the other hand, the defender seeks to maximise this performance measure under a maximum insertion distortion constraint D_{xy}_{_{—}}max. In the present case, Eb/N₀ represents the signal to noise ratio between the energy of the hidden message and the attack noise. This problem can then be solved using a Lagrangian formulation of the problem. The Lagrange factors λ>0 and χ>0 are then introduced, and the following subproblem dependent on (λ,χ) is considered, namely to find a general solution to equation (15) defined in Appendix II to the description.

The general solution is defined as the solution associated with the pair (λ,χ) resulting in a solution such that D_{xy′}=D_{xy′}_{_{—}}max and D_{xy}, D_{xy}_{_{—}}max.

In the above description, the search is located on (λ,χ) in order to satisfy the distortion constraints. The expression to be maximised at step 100 corresponds to the term {Eb/N₀+λ.D_{xy′}−χ.D_{xy}}. The last two terms being the Lagrangian terms associated respectively with the insertion and attack distortion. The terms associated with the constraint D_{xy′}_{_{—}}max and D_{xy}_{_{—}}max have been removed as they are constant, and also for reasons of simplicity.

It will be noted that the minimisation on the attack parameters (γi, σ_{δi}) has already been taken into account notably in the definition of the parameter γi in the first step.

The extraction of an embedded message following attacks is accomplished in two phases in the extraction device 2. In a first phase, a linear demodulation is performed in order to obtain observations \hat{b}j with jε[1,m]. The extracted message is then defined by seeking the code word close to the observations.

In the extraction device 2, the marked signal yi is resynchronised by the resynchronisation module 8, then transformed by the transformation module 7 into a series of coefficients yi′ using a transformation identical to that applied in the insertion phase.

The extraction module illustrated in FIG. 7 includes a demodulator 21 coupled to an extracted message decoder. The demodulator 21 calculates a response of the signal {yi′} to a demodulation of a second set of carriers Gⱼ supplied by a carrier generator 23, according to relationship (19) in Appendix II. This demodulation takes into account the perceptual weighting φi calculated on the basis of an analysis performed by a module 24 analysing the signal yi′.

The demodulation is based on the extraction of an estimate of the inserted message \hat{b}j by relationship (19) in Appendix II, at all of the marked sites.

It will be noted that any estimator defining a response proportional to this estimator can also be considered.

In an alternative embodiment, the second set of carriers is identical to the first set of carriers produced by the carrier generating module 16 of the insertion module.

Decoding of the message takes place after its estimated formatting \hat{b}j. It involves finding the code word Uₖ closest to the estimated values \hat{b}j by relationship (20) defined in Appendix II.

The message associated with the code word Uₖ then corresponds to the extracted message. An exhaustive search process can be used to perform the search for the closest code word, or any rapid search technique related to the definition of the code words used, by the use of a channel code decoding technique, for example.

It is to be noted that the invention is not limited to the embodiments described above.

Appendix I

I-1 Signals:

n: number of signal coefficients in the transform domain,

xi, iε[1, n]: values of signal coefficients in the transform space,

yi, iε[1, n]: values of signal coefficients in the transform space after marking.

yi′, iε[1, n]; values of signal coefficients in the transform space after marking, attacks and resynchronisation.

σₓᵢ², iε[1, n]: variance values of the signal in the transform space for the different coefficients.

D_{xy}=ΣD_{xy}|i: distortion between two signals x and y defined by relationship (1) formulated in Appendix II to the description.

φi; perceptual weighting for the i-th coefficient in the distortion metric. These weights are defined in relation to the type of signal processed, the transformation used, and the signal values observed.

D_{xy}: insertion distortion.

D_{xy′}: attack distortion.

(ai, bi, ci): variables identifying the system properties relative to the different insertion coefficients (variables between 0 and 1).

ai: degree of interference with the original signal.

bi: degree of auto interference of the inserted signal.

ci: attenuation parameter of a site (for example associated with its sensitivity to desynchronising attacks); this term depends on the transform space used and on the order of magnitude of the estimated desynchronisation error following the resynchronisation performed on extraction, and on the allowable degradation.

I-2 Working Variables:

(λ,χ): global auxiliary working variables used to define the insertion parameters of each coefficient in the transform domain.

(γi, σ_{wi}), iε{1, . . . , n}: auxiliary working variables defining the insertion parameters of each coefficient.

γi: attenuation factor.

σ_{wi}: energy weighting term of the mark added.

I-3 Modulation:

m: number of carriers used on insertion of the message.

bj with jε{1, . . . , m): information defining the information to be added in order to insert the message.

Gᵢⱼ with (i, j)ε{1, . . . , n}×{1, . . . , m}: information defining the known message insertion carriers at insertion and extraction. Any method of generating such carriers can be considered provided that they satisfy the condition Ei,j [Gᵢⱼ]=0 and Ei,j [Gᵢⱼ²]=1.

They can be generated for example via a secret key and a random number generator controlled by this secret key.

I-4 Code Word Dictionary

2^{C}: number of existing messages capable of being embedded in the signal.

U: set of code words used. 2^{C+R} m-ary code words are defined, and grouped into 2^{R} subsets U_{M} associated with the various existing messages M.

Uₖ: code word used, of size m and defined by the values Uₖⱼ with jε{1, . . . , m}.

I-5 Perceptual Parameter

φi: perceptual weights of distortion of the signal coefficients.

Appendix II

List of Formulae Used in the Description
D_{xy}=Σ_{iε[1,n]}φi².(xi−yi)² (1)
σₓᵢ²=(Σ_{jεvi} xi²)/|vi| (2)
φi²=1/(σ_{bi}²+Vi²) (3)
Vi=(Σ_{jεvi}|xi|^{ρ})/|vi| (4)
ai=bi=1−c^{z}i with ci=(sin c(Δi))^{d} (5),
where sin c (x)=sin (πx)/πx and d, the dimension of the signal considered (1 for a ID audio signal, 2 for an image, etc).
yi=k₁i.(xi+k₂ᵢ.Σ_{jε[1,m]}(bj.Gᵢⱼ)) (6),
with: k₁ᵢ=(σₓᵢ²/(σₓᵢ²+σ_{wi}²)
k₂ᵢ=σ_{wi}/√(Σ_{jε[1,m]}Gᵢⱼ²)
Uₖ=arg min_{UkεUM} {Σ_{jε[1,m]}(U_{k,j}−rxj)²} (7)
V′j=rxj−<rx|Uₖ>/√<Uₖ|Uₖ> (8)
Si<V′|V′>=0, Vj=0 (9)

Otherwise, Vj=Vj′.√M|√<V′|V′>.
{K.(u₀+cos θ)²−(v₀+sin θ)²} (10)
with:
u₀=1/m<rx∥Uₖ> (11)
v₀=1/m<rx∥V>
K=1/(2^{2.(C+R)/m}−1)
bj=U_{k,j}.cos θ+Vj.sin θ (12)

$${D}_{xy} = {\sum }_{i = 1}^{n} {D}_{xy} \vert i \\ {D}_{{xy}^{′}} = {\sum }_{i = 1}^{n} {D}_{{xy}^{′}} \vert i \\ Eb / {N}_{0} = {\sum }_{i = 1}^{n} Eb / {N}_{0} \vert i \qquad ( 13 )$$

with:
D_{xy}|i=φi²(σₓᵢ² σ_{wi}²)/(σₓᵢ²+σ_{wi}²) (14)
D_{xy′}|i=φi² σₓᵢ²(1−γi)
(Eb/N₀)|i=φi²√λci γi σ_{wi}
max_{owi} {min_{(γ}i,obi) {Eb/N₀+λ(D_{xy′}−D_{xy′}_{_{—}}max)−χ(D_{xy}−D_{xy}_{_{—}}max)}} (15)
γi=[σₓᵢ²−ci σ_{wi}/(φi√λ)]/[(1−ai)σₓᵢ²+(1−bi)σ_{wi}²] (17)
σ_{wi}=[Aᵢ.σₓᵢ²−ci²+√((Aᵢ.σₓᵢ²−c²i)²+Bᵢ²·σₓᵢ²)]/Bᵢ, (18)
γi=[σₓᵢ²−Dᵢ]/[(1−ai)(σₓᵢ²+σ_{wi}²)]
with
Aᵢ=φi²(λ−χ(1−ai))
Bᵢ=2 φi√λci
Dᵢ=ci.σ_{wi}/(φi.√λ)
\hat{b}j=Σ_{iεIw}(σi yi′ Gᵢⱼ) (19)
with Iw=set of marked sites.
Uₖ=arg max_{UkεU}{Σ_{jε[1,m]}(U_{k,j}−\hat{b}j)²} (20)

1. Signal processing device including a signal transformation module (5) capable of producing a transformed signal (xi) from an original signal and a mixing module (10) intended to mark the transformed signal by a marking message (M), characterised in that the mixing module (10) includes:
a formatting module (14) capable of calculating a response of the transformed original signal (rx) to the demodulation of a first set of carriers (Gj) defined by keys protecting the message, and of calculating a marking information ({bj}) based on this response and code words (U) associated with the marking message,
a modulator (18) capable of modulating the marking data supplied by the formatting module (14) with a given coefficient (Gij) of the carriers of the first set of carriers, and of modulating in amplitude the resulting coefficient by a corresponding quantity related to the energy weighting term of the marking message and to the set of carriers, thereby supplying a marking coefficient,
an adder (20) capable of adding the marking coefficient to the corresponding coefficient of the transformed original signal.

2. Device according to claim 1, characterised in that the formatting module (14) includes a demodulator (15) intended to perform the demodulation, said demodulator being capable of multiplying each coefficient of the transformed original signal (xi) by the corresponding coefficient of a given carrier (Gij) in the first set of carriers, by the perceptual weight of distortion (φi) and by the attenuation factor (γi) associated with said coefficient of the transformed signal, and to add the coefficients thus determined, thereby supplying a component of the response of the transformed original signal.

3. Device according to claim 1, characterised in that the formatting module (14) is capable of calculating the marking information from a predetermined parameter (θ), a first vector (Uk) associated with a particular code word of the marking message and a second vector forming in conjunction with said first vector a normalised orthogonal base defining a hyperplane.

4. Device according to claim 3, characterised in that the particular code word (Uk) is obtained by minimising a quadratic error criterion between the code words associated with the marking message and the normalised value of the response of the transformed signal (rx) to the demodulation.

5. Device according to claim 3, characterised in that each component (Vj) of the second vector is proportional to the difference between the corresponding component of the response (rxj) to the demodulation and the projection of the vector representing the response to the demodulation (rx) on a unit vector colinear with the first vector (Uk/∥Uk∥).

6. Device according to claim 3, characterised in that the predetermined parameter (θ) corresponds to the angle between the vector representing the marking information ({bj}) and the first vector (Uₖ), this parameter (θ) being determined by maximising the relationship:
K.(uo+cos θ)²−(vo+sin θ)²
in which:
uo represents the scalar product between the vector representing the response to the demodulation (rx) and the first vector, divided by the number m of components of the response to the demodulation,
vo represents the scalar product between the vector representing the response to the demodulation (rx) and the second vector (V), divided by the number m,
K=1/(2^{2(C+R)m}−1), C and R respectively denoting the number of useful bits and adaptation bits to the original signal, and m denotes the number of components of the demodulation response (rx).

7. Device according to claim 1, characterised in that the mixing module (10) includes a carrier generating module (16) capable of generating the first set of carriers from keys protecting the message (M).

8. Device according to claim 1, characterised in that the mixer includes a scaling module (17) capable of modulating in amplitude each signal coefficient supplied by the adder circuit (20) by a quantity related to the energy weighting term of the marking message (σ_{wi}) and the variance (σₓᵢ²) of the corresponding coefficient of the transformed original signal (xi).

9. Device according to claim 8, characterised in that said quantity is defined by σₓᵢ²/(σₓᵢ²+σ_{wi}²), where σxi² is the term defining the energy of the marking message and σₓᵢ² is the variance of the corresponding coefficient of the transformed original signal (xi).

10. Device according to claim 1, characterised in that it includes an inverse transformation module (6) at the output of the mixer (10), capable of performing an inverse transformation on the marked signal relative to that performed by the transformation module (5).

11. Device according to claim 10, characterised in that it includes an extraction device (2) at the output of the inverse transformation module (6) to extract the message from the marked signal, the extraction device including a resynchronisation module (8) capable of resynchronising the marked signal and a signal transformation module (7) capable of transforming the resynchronised marked signal, thereby supplying a transformed marked signal (yi′).

12. Device according to claim 11, characterised in that the transformation performed by the transformation module (7) of the extraction device is identical to that performed by the transformation module (5) to provide the coefficients of the transformed original signal.

13. Device according to claim 11, characterised in that the extraction device (2) is capable of calculating a response of the transformed marked signal (yi′) to the demodulation of a second set of carriers (Gj) defined by message protection keys, thereby providing an estimate of the marking information inserted (\hat{b}j).

14. Device according to claim 13, characterised in that the first set of carriers and the second set of carriers are identical.

15. Device according to claim 11, characterised in that the extraction device (2) includes a demodulator (21) intended to perform the demodulation, said demodulator being capable of multiplying each coefficient of the resynchronised marked signal (yi′) by the corresponding coefficient of a given carrier (Gij) of the second set of carriers and by the perceptual weight of distortion (φi) associated with said coefficient of the resynchronised marked signal, and of adding the coefficients thus determined, thereby providing a component of the estimate of the marking information (\hat{b}j).

16. Device according to claim 11, characterised in that the extraction device (2) includes a carrier generating module (16) capable of generating the second set of carriers from keys protecting the message (M).

17. Device according to claim 11, characterised in that the extraction device (2) includes a decoder (22) capable of determining the code word closest to the estimate of the marking information (\hat{b}j) by maximising a quadratic error criterion between a set of code words and the marking information estimate, thereby providing the marking message.

18. Device according to claim 1, characterised in that it includes an insertion parameters definition module (13) at the input to the mixing module (10) capable of determining the energy weighting term of the marking message (σ_{wi}) and the attenuation factor (yi) based on the intrinsic properties of the signal, the application domain constraints, and the properties of the transformation used.

19. Device according to claim 18, characterised in that the insertion parameters definition module (13) is capable of calculating two global insertion parameters (λ,χ) in relation to the insertion distortion D_{xy} between the original signal (x) and the marked signal (y) in the transform space, the maximum allowable attack distortion D_{xy′} between the original signal (x) and the resynchronised marked signal (y′) in the transform space, and the signal to noise ratio between the energy of the marking message and the attack noise Eb/No.

20. Device according to claim 19, characterised in that the two global insertion parameters (λ,χ) are calculated by searching for the parameters λ and χ which maximise the relationship: Eb/N₀+λD_{xy′}−χD_{xy}.

21. Device according to claim 20, characterised in that the insertion parameters definition module (13) is capable of calculating the energy weighting term of the marking message (σ_{wi}) and the attenuation factor (γi) from two determined global insertion parameters (λ,χ).

22. Device according to claim 1, characterised in that the coefficients of the transformed original signal (xi) supplied by the signal transformation module (5) are those of a Fourier transformation.

23. Device according to claim 1, characterised in that the coefficients of the transformed original signal (xi) supplied by the signal transformation module (5) are those of a cosine transformation.

24. Device according to claim 1, characterised in that the coefficients of the transformed original signal (xi) supplied by the signal transformation module (5) are those of a wavelet transformation.
